(19) United States
(12) Patent Application Publication
(10) Pub. No.: US 2013/0216093 A1
(43) Pub. Date: Aug. 22, 2013

(54) WALKING ASSISTANCE SYSTEM AND METHOD

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/454,007

(22) Filed: Apr. 23, 2012

(30) Foreign Application Priority Data
Feb. 21, 2012 (TW) 101105705

(51) Int. Cl. G06K 9/78

(52) U.S. Cl. 382/103

(57) ABSTRACT

An example walking assistance method includes obtaining an image captured by a camera. The image includes distance information indicating distances between the camera and objects captured by the camera. Next, the method determines whether one or more objects appear in the captured image. If yes, the method then creates a 3D scene model according to the captured image and the distances between the camera and objects captured by the camera. Next, the method determines whether one or more specific objects appear in the created 3D scene model, and further determines one or more obstacles appear when no specific object appears in the captured image. The method then creates an obstacle audio file based on the determined one or more obstacles, and further outputs the created obstacle audio file through an audio output device, to prompt one or more obstacles appear ahead.

### BACKGROUND

1. Technical Field

The present disclosure relates to walking assistance systems, and particularly, to a walking assistance system for the visually impaired or blind persons and a walking assistance method used by the system.

2. Description of Related Art

Visual impairment, compromised vision, or blindness may be a result of disease, genetic abnormalities, injuries, or age, for example. Visually impaired individuals (including those individuals with compromised vision and blindness) often use tactile or auditory feedback methods for navigating within small confines as well as in open and less familiar spaces. Adaptive technologies assist the visually impaired individual in completing daily activities, such as navigating, utilizing their remaining functioning organs of sense. Existing electronic navigational adaptive technologies rely on visual cues which are often unfamiliar to the user, and the user may be misinterpreted by the electronic navigational device. Accordingly, there is a need for new and improved adaptive technologies.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic diagram illustrating a walking assistance device connected with one camera, and an audio output device in accordance with an exemplary embodiment.

FIG. 2 is a block diagram of a walking assistance device of FIG. 1.

FIG. 3 is a flowchart of a walking assistance method in accordance with an exemplary embodiment.

### DETAILED DESCRIPTION

The embodiments of the present disclosure are now described in detail, with reference to the accompanying drawings.

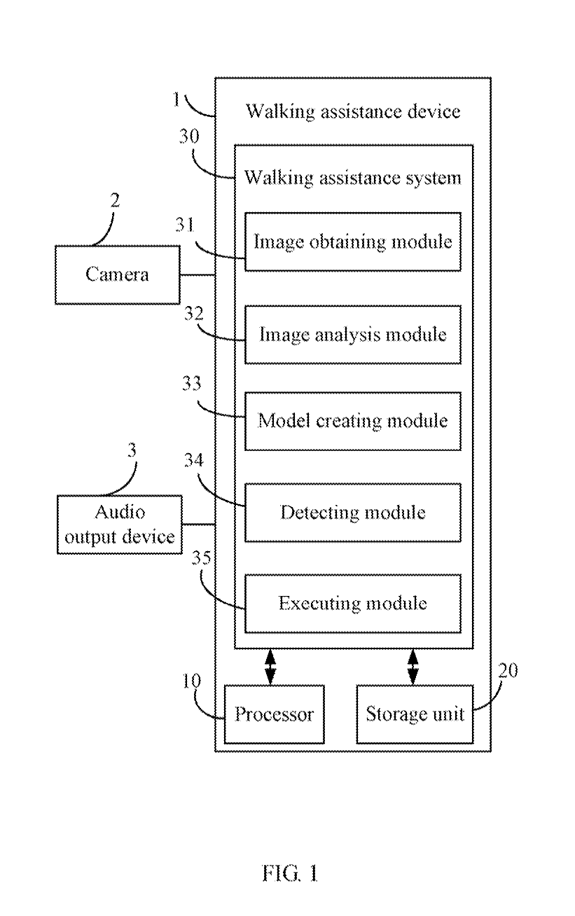

FIG. 1 is a schematic diagram illustrating a walking assistance device 1 that can assist the visually impaired or sightless persons. The walking assistance device 1 is connected to a camera 2 and an audio output device 3. The walking assistance device 1 can analyze an image captured by the camera 2 and determine whether one or more objects appear in the image, and further inform the user of the one or more objects through the audio output device 3. The one or more objects may include specific objects and obstacles. The specific objects can include but are not limited to a table, for example. The obstacles are a class of objects excluding the specific objects.

In the embodiment, the walking assistance device 1 is constructed in the form of a pair of glasses. The camera 2 is arranged on the walking assistance device 1 to capture images of the environment ahead of the user when the walking assistance device 1 is worn by the user. Each captured image includes distance information indicating the distance between one camera 2 and any object in the field of view of the camera 2. In the embodiment, the camera 2 is a Time of Flight (TOF) camera. In the embodiment, the audio output device 3 is an earphone.

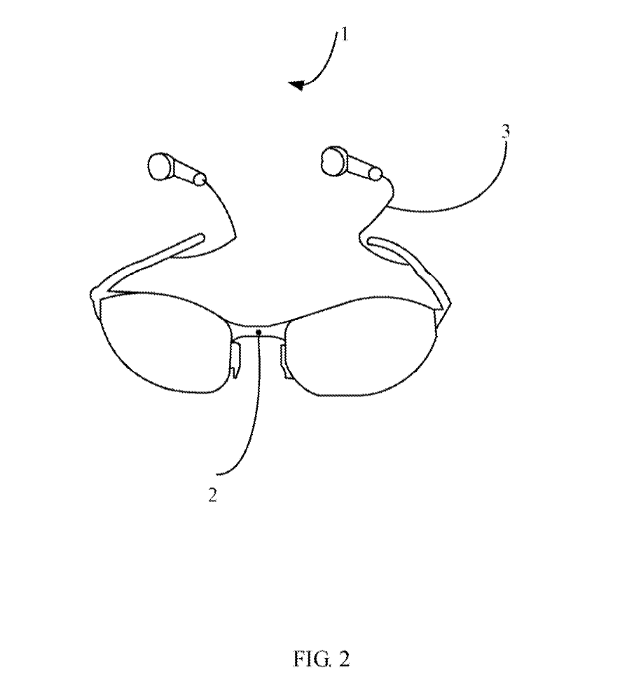

FIG. 2, shows the walking assistance device 1 including a processor 10, a storage unit 20, and a walking assistance system 30. In the embodiment, the walking assistance system 30 includes an image obtaining module 31, an image analysis module 32, a model creating module 33, a detecting module 34, and an executing module 35. One or more programs of the above function modules may be stored in the storage unit 20 and executed by the processor 10. In general, the word “module,” as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device.

In the embodiment, the storage unit 20 further stores a number of 3D specific object modules and a number of audio files. Each 3D specific object module has one unique name and a number of characteristic features. The 3D specific object models may be created based on a number of specific object images pre-collected by the camera 2 and the distance between the camera 2 and the specific object recorded in the pre-collected specific object images.

The audio files provide audio warnings to a user about the road ahead. In this embodiment, the audio files include a first audio file, a number of second audio files, and a number of third audio files. The first audio file contains a pre-recorded speech segment which represents the distance between the specific object and the user excluding the detail number, for example, there is a (null) ahead about (null) meters from here. Each second audio file contains pre-recorded speech segment which represents the name of one specific object, such as “desk”, and the obstacle. Each third audio file is pre-recorded speech segment which represents one detail number, such as “7”.

The image obtaining module 31 obtains the image captured by the camera 2.

The image analysis module 32 determines whether one or more objects appear in the captured image. In detail, the image analysis module 32 determines whether there are pixels of the captured image whose distance information indicates a distance less than a preset value, such as 20 meters. If so, the image analysis module 32 determines that one or more objects appear in the captured image. Otherwise, the image analysis module 32 determines that no object appears in the captured image.

The model creating module 33 creates 3D scene model according to the obtained image and the distances between the camera 2 and each of the one or more objects recorded in the obtained image when the image analysis module 32 determines one or more objects appear in the captured image.

The detecting module 34 determines whether one or more specific objects appear in the created 3D scene model. In detail, the detecting module 34 extracts object data corresponding to the shape of the one or more objects appearing in the created 3D scene model from the created 3D scene model, and compares the extracted object data with characteristic feature of each of the 3D specific object model, to determine whether one or more specific objects appear in the created 3D scene model. If the extracted object data does not match the characteristic data of any of the 3D specific object models, the detecting module 34 determines that no specific object appears in the created 3D scene model. If the extracted object data matches the character data of one or more of the 3D specific object models, the detecting module 34 determines one or more specific objects appear in the created 3D scene model. The detecting module 34 further determines one or more obstacles appear in the created 3D scene model when no specific object appears in the created 3D scene model, and determines the names of the one or more specific objects when one or more specific objects appear in the captured image.

The executing module 35 further obtains the first audio file, the second audio files corresponding to the determined names of the one or more specific objects, and the third audio files corresponding to the distances between the one or more specific objects and the camera 2 when one or more specific objects appear in the captured image, synthesize the obtained first audio file, the obtained second audio files, and the obtained third audio files to create a completely specific object audio file, such as “a chair appears ahead about 5 meters from here”, and further outputs the specific object audio file through the audio output device 3. Thus, the visually impaired or sightless person can determine the names of the one or more specific objects ahead and perform corresponding action according to the determined names of the one or more specific objects, such as going to sit on the determined chair, or placing things on the determined desk. Of course, the user can move past the determined one or more specific objects.

The executing module 35 further obtains the first audio file, the second audio file corresponding to the obstacle, and the third audio files corresponding to the distances between the determined obstacles and the camera 2 when one or more obstacles appears in the captured image. The executing module 35 further synthesizes the obtained first audio file, the obtained second audio file, and the obtained third audio files to create a completely obstacle audio file, such as “an obstacle appears ahead about 5 meters from here”, and further outputs the obstacle audio file through the audio output device 3. Thus the visually impaired or sightless person can move past the determined obstacle.

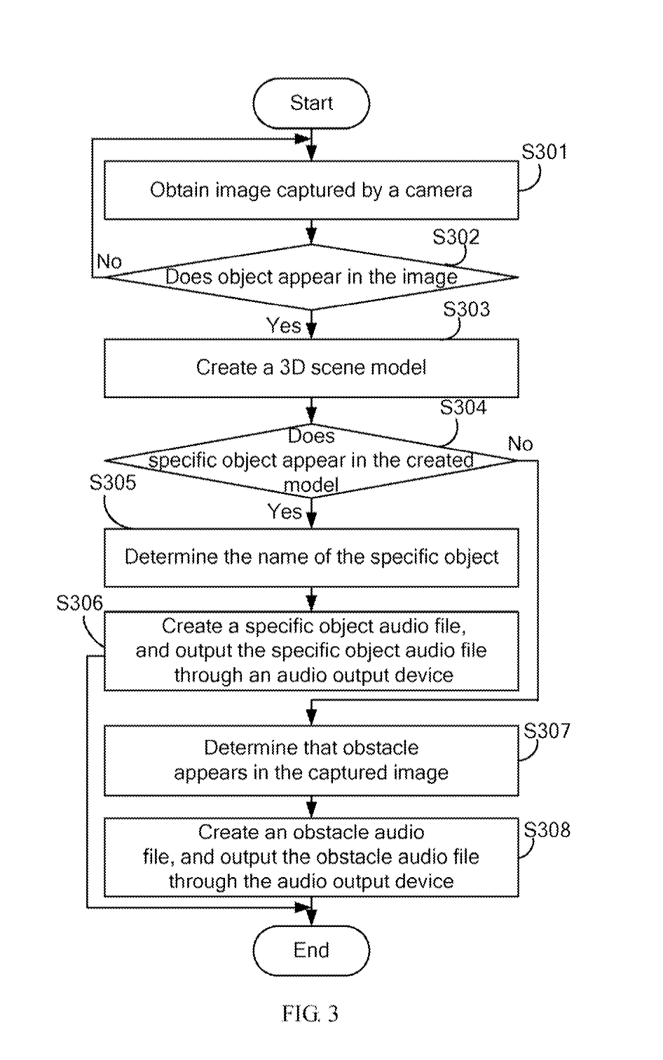

FIG. 3, shows a walking assistance method in accordance with an exemplary embodiment.

In step S301, the image obtaining module 31 obtains the image captured by the camera 2.

In step S302, the image analysis module 32 determines whether one or more objects appear in the captured image. When one or more objects appear in the captured image, the procedure goes to step S303. When no object appears in the captured image, the procedure goes to step S301. In detail, the image analysis module 32 determines whether there are pixels of the captured image whose distance information indicates a distance less than a preset value, such as 20 meters. If so, the image analysis module 32 determines that one or more objects appear in the captured image. Otherwise, the image analysis module 32 determines that no object appears in the captured image.

In step S303, the model creating module 33 creates a 3D scene model according to the obtained image and the distances between the camera 2 and each of the one or more objects recorded in the obtained image.

In step S304, the detecting module 34 detects whether one or more specific objects appear in the captured image. When one or more specific objects appear in the captured image, the procedure goes to step S305. When no specific object appears in the captured image, the procedure goes to step S307. In detail, the detecting module 34 extracts object data which corresponds to the shape of the one or more objects in the created 3D scene model from the created 3D scene model, and compares the extracted object data with character data of each of the 3D specific object model, to determine whether one or more specific objects appear in the captured image. If the extracted object data does not match the character data of any of the 3D specific object model, the detecting module 34 determines that no specific object appears in the captured image. If the extracted object data matches the character data of one or more of the 3D specific object models, the detecting module 34 determines one or more specific objects appear in the captured image.

In step S305, the detecting module 34 determines the names of the one or more specific objects.

In step S306, the executing module 35 obtains the first audio file, the second audio files corresponding to the determined names of the one or more specific objects, and the third audio files corresponding to the distances between the one or more specific objects and the camera 2, synthesizes the obtained first audio file, the obtained second audio files, and the obtained third audio files to create a completely specific object audio file, and further outputs the specific object audio file through the audio output device 3.

In step S307, the detecting module 34 determines one or more obstacles appear in the captured image.

In step S308, the executing module 35 obtains the first audio file, the second audio file corresponding to the obstacle, and the third audio files corresponding to the distances between the one or more obstacles and the camera 2, synthesizes the obtained first audio file, the obtained second audio file, and the obtained third audio files to create a complete obstacle audio file, and further outputs the obstacle audio file through the audio output device 3.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A walking assistance device comprising:
a storage system;
a processor;
one or more programs stored in the storage system, executable by the processor, the one or more programs comprising:
an image obtaining module operable to obtain an image captured by a camera, the image comprising a distance information indicating distances between the camera and objects captured by the camera;
an image analysis module operable to determine whether one or more objects appear in the captured image;
a model creating module operable to create a 3D scene model according to the captured image and the distances between the camera and objects captured by the camera when one or more objects appear in the captured image;
a detecting module operable to determine whether one or more specific objects appear in the created 3D scene model, and further determine that one or more obstacles appear when no specific object appears in the captured image; and
an executing module operable to create an obstacle audio file based on the determined one or more obstacles, and further output the created obstacle audio file through an audio output device, to prompt one or more obstacles appear ahead.

2. The walking assistance device as described in claim 1, wherein the image analysis module is operable to determine whether there are pixels of the captured image whose distance information indicates a distance less than a preset value; when there are pixels of the captured image whose distance information indicates a distance less than a preset value, the image analysis module is operable to determine that one or more objects appear in the captured image; when there are not pixels of the captured image whose distance information indicates a distance less than a preset value, the image analysis module is operable to determine that no object appears in the captured image.

3. The walking assistance device as described in claim 1, wherein the detecting module is further operable to determine the names of the one or more specific objects when one or more specific objects appear in the captured image, the executing module is operable to create a specific object audio file according to the names of the one or more specific objects, and further output the specific object audio file through the audio output device, to prompt that one or more specific objects appear ahead.

4. The walking assistance device as described in claim 3, wherein the detecting module is further operable to extract object data corresponding to the shape of the one or more objects in the created 3D scene model from the created 3D scene model, and compare the object data with characteristic feature of each of the 3D specific object models, to determine whether one or more specific objects appear in the created 3D scene model; if the extracted object data does not match the characteristic feature of any of the 3D specific object model, the detecting module is operable to determine that no specific object appears in the captured image; if the object data matches the characteristic feature of one or more of the 3D specific object models, the detecting module is operable to determine that one or more specific objects appear in the captured image.

5. The walking assistance device as described in claim 1, wherein the executing module is further operable to obtain a stored first audio file, a stored second audio file corresponding to the one or more obstacles, and third audio files corresponding to the distances between the one or more obstacles and the camera, and further synthesize the obtained first audio file, the obtained second audio file, and the obtained third audio files to create the obstacle audio file.

6. The walking assistance device as described in claim 3, wherein the executing module is further operable to obtain a stored first audio file, stored second audio files corresponding to the determined names of the one or more specific objects, and third audio files corresponding to the distances between the one or more specific objects and the camera, and further synthesize the obtained first audio file, the obtained second audio files, and the obtained third audio files to create the specific object audio file.

7. A walking assistance method comprising:
obtaining an image captured by a camera, the image comprising a distance information indicating distances between the camera and objects captured by the camera;
determining whether one or more objects appear in the captured image;
creating a 3D scene model according to the captured image and the distances between the camera and objects captured by the camera when one or more objects appear in the captured image;
determining whether one or more specific objects appear in the created 3D scene model, and further determining that one or more obstacles appear when no specific object appears in the captured image; and
creating an obstacle audio file based on the determined one or more obstacles, and further outputting the created obstacle audio file through an audio output device, to prompt one or more obstacles appear ahead.

8. The walking assistance method as described in claim 7, wherein the method further comprises:
determining whether there are pixels of the captured image whose distance information indicates a distance less than a preset value;
determining that one or more objects appear in the captured image when there are pixels of the captured image whose distance information indicates a distance less than a preset value; and
determining that no object appears in the captured image when there are not pixels of the captured image whose distance information indicates a distance less than a preset value.

9. The walking assistance method as described in claim 7, wherein the method further comprises:
determining the names of the one or more specific objects when one or more specific objects appear in the captured image; and
creating a specific object audio file according to the names of the one or more specific objects, and further outputting the specific object audio file through the audio output device, to prompt that one or more specific objects appear ahead.

10. The walking assistance method as described in claim 9, wherein the method further comprises:
extracting object data corresponding to the shape of the one or more objects in the created 3D scene model from the created 3D scene model, and comparing the object data with characteristic feature of each of the 3D specific object models, to determine whether one or more specific objects appear in the created 3D scene model;
determining that no specific object appears in the captured image if the extracted object data does not match the characteristic feature of any of the 3D specific object model;
determining that one or more specific objects appear in the captured image if the object data matches the characteristic feature of one or more of the 3D specific object models.

11. The walking assistance method as described in claim 7, wherein the method further comprises:
obtaining a stored first audio file, a stored second audio file corresponding to the one or more obstacles, and third audio files corresponding to the distances between the one or more obstacles and the camera, and further synthesizing the obtained first audio file, the obtained second audio file, and the obtained third audio files to create the obstacle audio file.

12. The walking assistance method as described in claim 9, wherein the method further comprises:
obtaining a stored first audio file, stored second audio files corresponding to the determined names of the one or more specific objects, and third audio files corresponding to the distances between the one or more specific objects and the camera, and further synthesizing the obtained first audio file, the obtained second audio files, and the obtained third audio files to create the specific object audio file.

13. A storage medium storing a set of instructions, the set of instructions capable of being executed by a processor of a walkingassistance device, cause the walking assistance device to perform a walking assistance method, the method comprising:
obtaining an image captured by a camera, the image comprising a distance information indicating distances between the camera and objects captured by the camera;
determining whether one or more objects appear in the captured image;
creating a 3D scene model according to the captured image and the distances between the camera and objects captured by the camera when one or more objects appear in the captured image;
determining whether one or more specific objects appear in the created 3D scene model, and further determining that one or more obstacles appear when no specific object appears in the captured image; and
creating an obstacle audio file based on the determined one or more obstacles, and further outputting the created obstacle audio file through an audio output device, to prompt one or more obstacles appear ahead.

14. The storage medium as described in claim 13, wherein the method further comprises:
determining whether there are pixels of the captured image whose distance information indicates a distance less than a preset value;
determining that one or more objects appear in the captured image when there are pixels of the captured image whose distance information indicates a distance less than a preset value; and
determining that no object appears in the captured image when there are not pixels of the captured image whose distance information indicates a distance less than a preset value.

15. The storage medium as described in claim 13, wherein the method further comprises:
determining the names of the one or more specific objects when one or more specific objects appear in the captured image; and
creating a specific object audio file according to the names of the one or more specific objects, and further outputting the specific object audio file through the audio output device, to prompt that one or more specific objects appear ahead.

16. The storage medium as described in claim 15, wherein the method further comprises:
extracting object data corresponding to the shape of the one or more objects in the created 3D scene model from the created 3D scene model, and comparing the object data with characteristic feature of each of the 3D specific object models, to determine whether one or more specific objects appear in the created 3D scene model;
determining that no specific object appears in the captured image if the extracted object data does not match the characteristic feature of any of the 3D specific object model;
determining that one or more specific objects appear in the captured image if the object data matches the characteristic feature of one or more of the 3D specific object models.

17. The storage medium as described in claim 13, wherein the method further comprises:
obtaining a stored first audio file, a stored second audio file corresponding to the one or more obstacles, and third audio files corresponding to the distances between the one or more obstacles and the camera, and further synthesizing the obtained first audio file, the obtained second audio file, and the obtained third audio files to create the obstacle audio file.

18. The storage medium as described in claim 15, wherein the method further comprises:
obtaining a stored first audio file, stored second audio files corresponding to the determined names of the one or more specific objects, and third audio files corresponding to the distances between the one or more specific objects and the camera, and further synthesizing the obtained first audio file, the obtained second audio files, and the obtained third audio files to create the specific object audio file.
